(19) United States
(12) Patent Application Publication
(10) Pub. No.: US 2021/0352944 A1
(43) Pub. Date: Nov. 18, 2021

(54) NON-BITTER LOW-SODIUM SALT CONTAINING DIET FIBER CARRAGEENAN, METHOD FOR PREPARING THE SAME AND APPLICATION THEREOF

(71) Applicant: Shanghai Jiao Tong University, Shanghai (CN)

(72) Inventors: Yapeng FANG, Shanghai (CN); Wei LU, Shanghai (CN); Cuixia SUN, Shanghai (CN); Yiguo ZHAO, Shanghai (CN); Xuelian ZHOU, Shanghai (CN)

(73) Assignee: Shanghai Jiao Tong University, Shanghai (CN)

(21) Appl. No.: 17/388,025

(22) Filed: Jul. 29, 2021

Related U.S. Application Data
(63) Continuation of application No. PCT/CN2019/093847, filed on Jun. 28, 2019.

(30) Foreign Application Priority Data
Jan. 30, 2019 (CN) 201910093972.2

(51) Int. Cl. A23L 27/40; A23L 29/256; A23P 10/22; A23L 3/40

(52) U.S. Cl. CPC A23L 27/40; A23L 29/256; A23V 2002/00; A23L 3/40; A23P 10/22

(57) ABSTRACT

The invention relates to a non-bitter low-sodium salt containing diet fiber carrageenan, a method for preparing the same and an application thereof. The non-bitter low-sodium salt containing diet fiber carrageenan is a solid salt and is prepared from 40-60 portion by weight of sodium chloride, 40-60 portion by weight of potassium chloride and 4-18 portion by weight of kappa-carrageenan by performing dissolving, mixing, drying, grinding and sieving. According to the invention, based on the mechanism that sulfate groups on kappa-carrageenan molecules can specifically bind to potassium ions, kappa-carrageenan is added to chelate potassium ions, thereby effectively masking the bitter taste of potassium chloride and significantly enhancing the salty taste of low-sodium salt as compared with the prior art. Carrageenan used in the invention is a common food additive which is easily available and cost-effective, so that the invention has good prospect in industrial popularization.

### CROSS-REFERENCE TO RELATED APPLICATION

This application is a continuation of international application of PCT application serial no. PCT/CN2019/093847 filed on Jun. 28, 2019, which claims the priority benefit of China application no. 201910093972.2 filed on Jan. 30, 2019. The entirety of each of the above mentioned patent applications is hereby incorporated by reference herein and made a part of this specification.

### BACKGROUND

### Technical Field

The invention belongs to the technical field of edible salt preparation, and particularly relates to a non-bitter low-sodium salt containing diet fiber carrageenan, a method for preparing the same and an application thereof.

As the main salty flavor substance, sodium chloride is essential in food processing and daily life. In recent years, the harm of high sodium diet to health has attracted worldwide attention. It is reported that nearly 20% of the deaths caused by cardiovascular diseases may be attributed to the increase of systolic blood pressure caused by high sodium diet. Studies have also shown that high salt intake significantly increases the risk of heart failure, causes disorder of intestinal microbes, and induces osteoporosis, gastric cancer, diabetes and obesity. At present, the average salt intake is 9-12 g/person/day worldwide, and it is as high as 14-15 g/person/day in northern China, far higher than the 5 g/person/day recommended by the World Health Organization. Therefore, it is a great challenge to reduce the salt content of products and the absorption of sodium in the body without affecting the taste, processing quality and shelf life of food.

At present, the food industry mainly reduces the usage of sodium chloride by changing the formula of salt and using salt substitutes. Commonly used salt substitutes include: (1) inorganic salt substitutes, including, for example, potassium chloride, magnesium chloride, magnesium sulfate, potassium lactate, calcium lactate. Potassium, calcium and magnesium have similar physical and chemical properties and salty taste because they are close to sodium in position in the periodic table of elements and are also essential minerals for the human body. Therefore, they are often added to salt as salt substitute with an objective of salt-reduction; (2) sodium malate, sodium gluconate, salty polypeptide, etc. Sodium malate and sodium gluconate are the main salty ingredients of salt-free soy sauce and are also the main salty ingredients taken by patients with kidney diseases. Some amino acids and peptides can also provide salty and delicious taste and are often added to salt as auxiliaries. Among these salt substitutes, potassium chloride can provide salty taste to a certain extent and promote sodium excretion. In addition, lots of people have potassium deficiency. For example, the average potassium intake in China is about 1.6 g/person/day, far below the recommended healthy dose of around 3.5 g/person/day. Thus, potassium chloride is widely recognized as a suitable salt substitute. However, it has a strong metallic bitter taste, which causes discomfort to consumers and thus significantly limit its use as salt substitute. At present, the main way to mask the bitter taste of potassium chloride is to add food flavors such as saccharides, amino acid, or peptides, and mix them directly with salt, so as to cover up the bitter taste of potassium chloride with their special flavor. However, all these methods cannot significantly mask the bitter taste of salt containing potassium chloride when the low-sodium salt is directly applied to the surface of French fries, potato chips, or biscuits. In addition, the introduction of these flavors always negatively influences the taste and quality of the food products. Therefore, how to improve the bitter taste of low-sodium salt containing potassium chloride is a problem that must be solved.

Carrageenan, a kind of hydrophilic polysaccharide extracted from algae, is composed of galactose and 3,6-anhydrogalactose linked through α-1,3-glycosidic bond and β-1,4-bond alternately. The 1,3-connected D-galactose unit contains a sulfate group at C4. Carrageenan mainly includes κ-type, i-type and λ-type.

Chinese patent CN108029978A discloses a marinade composite salt and a method for preparing the same. The marinade composite salt includes carrageenan 4%-9%, xanthan gum 1%-2%, potassium chloride 0.3%-1.5%, ingredient A 15%-30%, ingredient B 5%-10%, ingredient C 7%-15%, ingredient D 0.1%-4%, starch 3%-6%, table salt 24%-52%, and white granulated sugar 5%-10%, with the total weight percentage being 100%. The composite salt mainly uses carrageenan and xanthan gum to improve the toughness and taste of marinated products by using the water retention property of carrageenan; also, using the gelling property of carrageenan, the gel product can be evenly divided, which makes the product convenient to use, prolongs shelf life and retains the aroma.

Chinese patent CN105410856A discloses a composite seasoning salt rich in organic selenium and a method for preparing the same. A composite seasoning salt rich in organic selenium, consisting of the following components in parts by mass: 5-9 parts of selenium-enriched yeast, 80-98 parts of sodium chloride, 7-11 parts of yeast extract, 4-8 parts of kappa-selenocarrageenan, 35-56 parts of potassium chloride, 13-18 parts of chicken powder, 10-15 parts of refined animal oil, 8-12 parts of termite mushroom powder, 6-10 parts of lentinula edodes powder, 3-8 parts of compound amino acids, 3-8 parts of selenium-enriched konjac powder and 2-6 parts of powdery edible flowers. Sodium chloride, potassium chloride, selenium-enriched yeast, yeast extract and amino acid are well mixed in a stirrer; deionized water is added to dissolve them; the mixture is heated to 80° C., stirred until completely dissolved; refined animal oil, chicken powder, kappa-selenocarrageenan, lentinus edodes powder, and termite mushroom powder are added, and the mixture is stirred for 30 min; the mixture is spray-dried using a centrifugal spray drying tower to obtain granular products. This patent uses potassium chloride as a substitute for sodium chloride to produce salty taste. This patent uses compound amino acids, chicken powder, yeast, termite mushroom powder and lentinus edodes powder to cover and balance the bitter taste of potassium chloride and improve the taste of potassium-rich low-sodium salt.

Chinese patent CN109170572A discloses a method for preparing noodles with low glycemic index, which comprises the following steps: based on 100% of flour, the proportions of food thickeners are respectively: konjac gum 0.1-5%, sodium alginate 0.1-5%, carrageenan 0.1-5%, sodium carboxymethyl cellulose 0.1-5%, xanthan gum 0.1-5%, guar gum 0.1-5% The proportions of composite salts are sodium salt 0.01-3%, potassium salt 0.005-2% and calcium salt 0.005-2%. Blending: according to the requirements of raw and auxiliary materials of flour products such as noodles, bread and steamed bread, all the ingredients except flour and food thickeners are added into flour and well stirred; dough kneading; dough proofing (aging and proofing); rolling, slitting and drying; fermentation, shaping, proofing and baking; thereby producing bread with low glycemic index which can be 30% and 50% lower than that of normal flour foods. In this patent, carrageenan is used as food thickener.

It can be seen that there were some reports using carrageenan in flavoring agents or foods, but there is no technology related to how to use carrageenan to prepare non-bitter low-sodium salt.

### SUMMARY

The objective of the invention is to provide a non-bitter low-sodium salt containing diet fiber carrageenan, a method for preparing the same and an application thereof in order to overcome the defects in the prior art.

The objective of the invention can be achieved by the following technical solution.

A non-bitter low-sodium salt containing diet fiber carrageenan, which is a solid salt, and is prepared from 40-60 portion by weight of sodium chloride, 40-60 portion by weight of potassium chloride and 4-18 portion by weight of kappa-carrageenan by carrying out dissolving, mixing, drying, grinding and sieving.

A method for preparing a non-bitter low-sodium salt containing diet fiber carrageenan, which comprises steps of:

(1) dissolving ingredients:

preparing a kappa-carrageenan solution and a mixed solution of sodium chloride and potassium chloride

(2) mixing ingredients:

mixing the prepared mixed solution of sodium chloride and potassium chloride with the kappa-carrageenan solution to form gel;

(3) drying, grinding and sieving the gel to obtain a solid salt:

drying the gel obtained in the step (2) to remove water, and then carrying out grinding and sieving to obtain a solid salt with uniform particles, namely a non-bitter low-sodium salt containing diet fiber carrageenan.

Further, a gel system in the step (2) comprises 40-60 portion by weight of sodium chloride, 40-60 portion by weight of potassium chloride and 4-18 portion by weight of kappa-carrageenan.

Further, in the step (1), the kappa-carrageenan solution is prepared from kappa-carrageenan and water.

Further, in the step (1), the kappa-carrageenan solution is prepared by carrying out heating and magnetic stirring, and the kappa-carrageenan solution has a concentration of 1-5%.

Further, in the step (1), the kappa-carrageenan is dissolved by carrying out magnetic stirring at 70° C. for 30 min.

Further, in the step (1), an aqueous sodium chloride solution and an aqueous potassium chloride solution are prepared separately, or a mixed aqueous solution of sodium chloride and potassium chloride is prepared at one time.

Further, in the step (1), sodium chloride and potassium chloride are dissolved at 70° C. for 5 min in water bath.

Further, in the step (2), the prepared mixed solution of sodium chloride and potassium chloride is added into the kappa-carrageenan solution, and magnetic stirring is carried out at 70° C. for 30 min to form gel.

Further, in the step (3), the drying is carried out by means of blast drying at 40-50° C. for 3-4 d.

Further, in the step (3), a grinder can be used for grinding.

Further, in the step (3), a 100-mesh sieve can be used for screening to obtain a solid salt with a mean particle size of about 100 μm.

The non-bitter low-sodium salt containing diet fiber carrageenan is used for preparing flavoring agents, including but not limited to instant soups, condiments including monosodium glutamate, and instant noodle seasonings.

The non-bitter low-sodium salt containing diet fiber carrageenan is used for preparing fried foods, cooked wheaten foods, dairy products, processed meat foods and canned foods.

Kappa-carrageenan can interact with monovalent metal ions to promote gel reaction, and has unique properties such as thermal reversible gelation, anti-protein coagulation, being hydrophilicity and nontoxic.

Therefore, according to the invention, based on the mechanism that sulfate groups on kappa-carrageenan molecules can specifically bind to potassium ions, kappa-carrageenan is added to chelate potassium ions, thereby effectively improving the bitter taste of potassium chloride and obviously enhancing the salty taste of low-sodium salt. Carrageenan used in the invention is a common food additive which is easily available and cost-effective, so that the invention has good prospect in industrial popularization.

### BRIEF DESCRIPTION OF THE DRAWINGS

FIG. 1 shows an SEM image of the solid salt obtained in Example 1.

FIG. 2 shows a picture of the solid salt obtained in Example 1.

FIG. 3 shows the sensory evaluation results of salty taste and bitter taste of different salts.

FIG. 4 shows the result of sensory analysis of flavor profile when different salts are applied to French fries.

### DESCRIPTION OF THE EMBODIMENTS

The invention will be described in detail with reference to the drawings and specific examples.

### Example 1

Preparation of Raw Materials: 10 g of Sodium Chloride, 10 g of Potassium Chloride and 1 g of Carrageenan

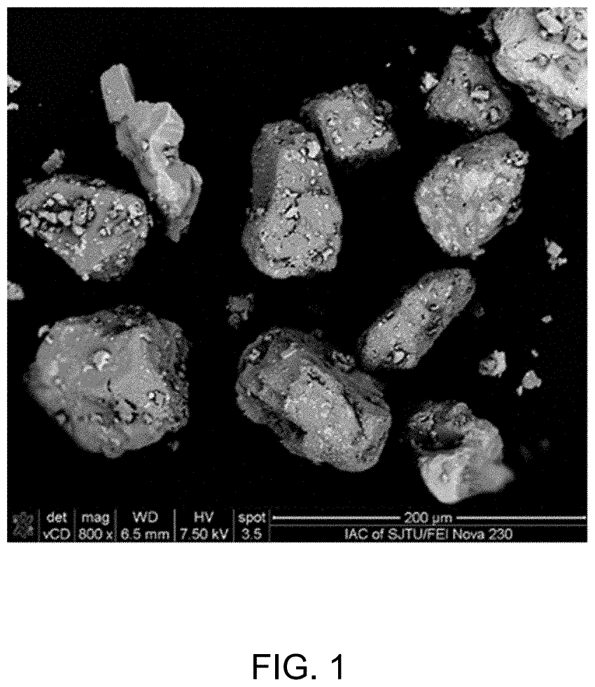

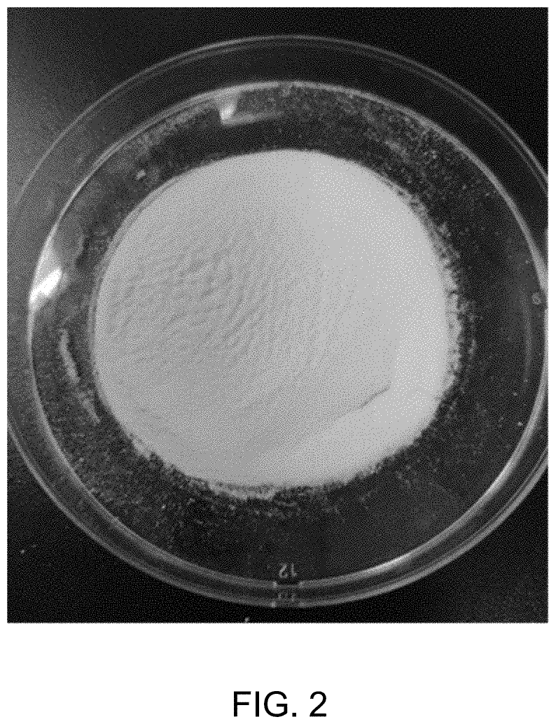

Carrageenan was dissolved in 100 ml of water, and magnetically stirred at 70° C. for 30 min. Potassium chloride and sodium chloride were mixed and dissolved in 100 ml of water, and magnetically stirred at 70° C. for 5 min. The carrageenan solution was mixed with the sodium chloride and potassium chloride solution to form gel, and dried in a blast drying oven at 45° C. for 3 d. Then, the resulting product was ground with an IKA grinder and sieved with a 100-mesh sieve to obtain a solid salt. The SEM image and picture of solid salt obtained in this example are shown in FIG. 1 and FIG. 2, respectively.

### Example 2

Preparation of Raw Materials: 10 g of Sodium Chloride, 10 g of Potassium Chloride and 2 g of Carrageenan

Carrageenan was dissolved in 100 ml of water, and magnetically stirred at 70° C. for 30 min. Potassium chloride and sodium chloride were mixed and dissolved in 100 ml of water, and magnetically stirred at 70° C. for 5 min. The carrageenan solution was mixed with the sodium chloride and potassium chloride solution to form gel, and dried in a blast drying oven at 45° C. for 3 d. Then, the resulting product was ground with an IKA grinder and sieved with a 100-mesh sieve to obtain a solid salt.

### Example 3

Preparation of Raw Materials: 10 g of Sodium Chloride, 10 g of Potassium Chloride and 3 g of Carrageenan

Carrageenan was dissolved in 100 ml of water, and magnetically stirred at 70° C. for 30 min. Potassium chloride and sodium chloride were mixed and dissolved in 100 ml of water, and magnetically stirred at 70° C. for 5 min. The carrageenan solution was mixed with the sodium chloride and potassium chloride solution to form gel, and dried in a blast drying oven at 45° C. for 3 d. Then, the resulting product was ground with an IKA grinder and sieved with a 100-mesh sieve to obtain a solid salt.

### Example 4

Preparation of Raw Materials: 10 g of Sodium Chloride, 10 g of Potassium Chloride and 4 g of Carrageenan

Carrageenan was dissolved in 100 ml of water, and magnetically stirred at 70° C. for 30 min. Potassium chloride and sodium chloride were mixed and dissolved in 100 ml of water, and magnetically stirred at 70° C. for 5 min. The carrageenan solution was mixed with the sodium chloride and potassium chloride solution to form gel, and dried in a blast drying oven at 45° C. for 3 d. Then, the resulting product was ground with an IKA grinder and sieved with a 100-mesh sieve to obtain a solid salt.

### Example 5

Preparation of Raw Materials: 10 g of Sodium Chloride, 10 g of Potassium Chloride and 5 g of Carrageenan

Carrageenan was dissolved in 100 ml of water, and magnetically stirred at 70° C. for 30 min. Potassium chloride and sodium chloride were mixed and dissolved in 100 ml of water, and magnetically stirred at 70° C. for 5 min. The carrageenan solution was mixed with the sodium chloride and potassium chloride solution to form gel, and dried in a blast drying oven at 45° C. for 3 d. Then, the resulting product was ground with an IKA grinder and sieved with a 100-mesh sieve to obtain a solid salt.

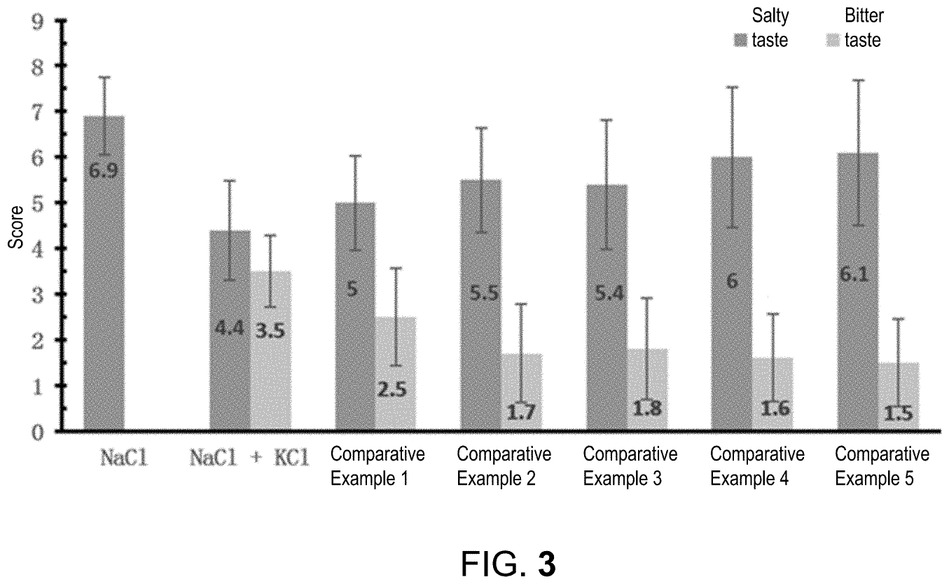

Pure sodium chloride, a mixed salt of 50% sodium chloride and 50% potassium chloride, and the solid salts obtained in Examples 1-5 were respectively prepared into aqueous solutions with the same and appropriate sensory concentration, with the salt concentration of the solutions being 6%. Fifteen sensory evaluation professionals were invited to carry out sensory evaluation on their salty taste and bitter taste, and the results are showed in FIG. 3. As shown, the carrageenan content gradually increases from Example 1 to Example 5, and the bitter taste of potassium chloride in the salt solutions gradually decreases with the increasing carrageenan content; and the salty taste of the salt solution system is also improved. Also, there is a significant difference between samples with and without carrageenan.

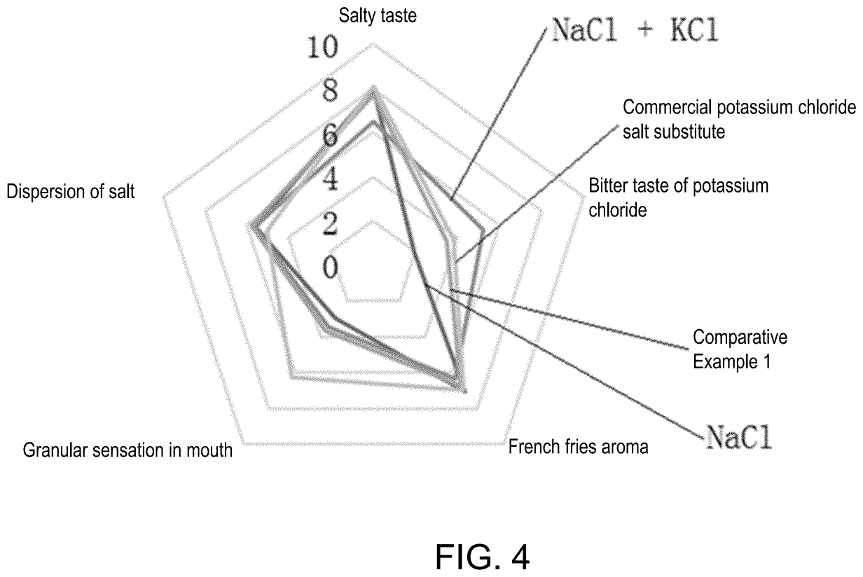

The solid salt obtained in Example 1, pure sodium chloride, a mixed salt of 50% sodium chloride and 50% potassium chloride, and a commercial potassium chloride salt substitute were applied to French fries, 1.5 g of salt per 100 g of French fries. Sensory analysis of flavor profile was carried out, and the results are shown in FIG. 4. The low-sodium salt containing diet fiber carrageenan in Example 1 can achieve similar salty taste and mouthfeel to pure sodium chloride and commercial potassium chloride substitute salt and does not affect the aroma of French fries. For the invention, compared with the mixed system of sodium chloride and potassium chloride without carrageenan, the bitter taste of potassium chloride is significantly reduced by adding carrageenan, and the granular sensation is low due to small particle size of the low-sodium salt.

The above description of the embodiments is for the convenience of those of ordinary skill in the art to understand and use the invention. It is obvious that those skilled in the art can easily make various modifications to these embodiments and apply the general principles described herein to other embodiments without creative labor. Therefore, the invention is not limited to the above embodiments, and improvements and modifications made by those skilled in the art according to the disclosure of the invention without departing from the scope of the invention should be within the scope of protection of the invention.

What is claimed is:

1. A non-bitter low-sodium salt containing diet fiber carrageenan, wherein the non-bitter low-sodium salt is a solid salt and is prepared from 40-60 portion by weight of sodium chloride, 40-60 portion by weight of potassium chloride and 4-18 portion by weight of kappa-carrageenan by carrying out dissolving, mixing, drying, grinding and sieving.

2. A method for preparing a non-bitter low-sodium salt containing diet fiber carrageenan, comprising steps of:
step (1) dissolving ingredients:
preparing a kappa-carrageenan solution and a mixed solution of sodium chloride and potassium chloride;
step (2) mixing ingredients:
mixing the prepared mixed solution of sodium chloride and potassium chloride with the kappa-carrageenan solution to form gel; and
step (3) drying, grinding and sieving the gel to obtain a solid salt:
drying the gel obtained in the step (2) to remove water, and then carrying out grinding and sieving to obtain a solid salt with uniform particles, which is the non-bitter low-sodium salt containing diet fiber carrageenan.

3. The method for preparing a non-bitter low-sodium salt containing diet fiber carrageenan according to claim 2, wherein a gel system in the step (2) comprises 40-60 portion by weight of sodium chloride, 40-60 portion by weight of potassium chloride and 4-18 portion by weight of kappa-carrageenan.

4. The method for preparing a non-bitter low-sodium salt containing diet fiber carrageenan according to claim 2, wherein in the step (1), the kappa-carrageenan solution is prepared from kappa-carrageenan and water.

5. The method for preparing a non-bitter low-sodium salt containing diet fiber carrageenan according to claim 2, wherein in the step (1), the kappa-carrageenan solution is prepared by carrying out heating and magnetic stirring, and the kappa-carrageenan solution has a concentration of 1-5%.

6. The method for preparing a non-bitter low-sodium salt containing diet fiber carrageenan according to claim 2, wherein in the step (1), an aqueous sodium chloride solution and an aqueous potassium chloride solution are prepared separately, or a mixed aqueous solution of sodium chloride and potassium chloride is prepared at one time.

7. The method for preparing a non-bitter low-sodium salt containing diet fiber carrageenan according to claim 2, wherein in the step (2), the prepared mixed solution of sodium chloride and potassium chloride is added into the kappa-carrageenan solution, and magnetic stirring is carried out at 70° C. for 30 min to form gel.

8. The method for preparing a non-bitter low-sodium salt containing diet fiber carrageenan according to claim 2, wherein in the step (3), the drying is carried out by means of blast drying at 40-50° C. for 3-4 d.

9. An application of the non-bitter low-sodium salt containing diet fiber carrageenan according to claim 1, wherein the non-bitter low-sodium salt containing diet fiber carrageenan is used for preparing flavoring agents, including but not limited to instant soups, condiments including monosodium glutamate, and instant noodle seasonings.

10. An application of the non-bitter low-sodium salt containing diet fiber carrageenan according to claim 1, wherein the non-bitter low-sodium salt containing diet fiber carrageenan is used for making fried foods, cooked wheaten foods, dairy products, processed meat foods and canned foods.

11. The method for preparing a non-bitter low-sodium salt containing diet fiber carrageenan according to claim 4, wherein in the step (1), the kappa-carrageenan solution is prepared by carrying out heating and magnetic stirring, and the kappa-carrageenan solution has a concentration of 1-5%.
